(19) United States
(12) Patent Application Publication
(10) Pub. No.: US 2007/0190245 A1
(43) Pub. Date: Aug. 16, 2007

(54) Method of coating gas turbine components

(75) Inventors: Bhupendra K. Gupta, Cincinnati, OH (US); Nripendra Nath Das, West Chester, OH (US); Mathew David Saylor, Blanchester, OH (US); Robert G. Zimmerman JR., Morrow, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/354,363

(22) Filed: Feb. 15, 2006

(51) Int. Cl. B05D 7/22

(52) U.S. Cl. 427/237

(57) ABSTRACT

A method of forming a metal coating on surfaces of internal passages of a turbine part includes applying a nickel aluminum bond coating to an external surface of the turbine part, positioning the turbine part in a VPA chamber, coupling a gas manifold to at least one internal passage inlet, and coating at least a portion of the internal surface and the external of the turbine part by a vapor phase aluminiding (VPA) process using metal coating gases to form a coating on the internal surfaces of the turbine part.

### BACKGROUND OF THE INVENTION

This invention relates generally to gas turbine engines, and more particularly, to methods of depositing protective coatings on components of gas turbine engines.

Gas turbine engines typically include high and low pressure compressors, a combustor, and at least one turbine. The compressors compress air which is mixed with fuel and channeled to the combustor. The mixture is then ignited for generating hot combustion gases, and the combustion gases are channeled to the turbine which extracts energy from the combustion gases for powering the compressor, as well as producing useful work to propel an aircraft in flight or to power a load, such as an electrical generator.

The operating environment within a gas turbine engine is both thermally and chemically hostile. Significant advances in high temperature alloys have been achieved through the formulation of iron, nickel and cobalt-base superalloys, though components formed from such alloys often cannot withstand long service exposures if located in certain sections of a gas turbine engine, such as the turbine, combustor and augmentor. A common solution is to provide turbine, combustor and augmentor components with an environmental coating that inhibits oxidation and hot corrosion, or a thermal barrier coating (TBC) system that, in addition to inhibiting oxidation and hot corrosion, also thermally insulates the component surface from its operating environment.

Coating materials that have found wide use as environmental coatings include diffusion aluminide coatings, which are generally single-layer oxidation-resistant layers formed by a diffusion process, such as pack cementation. Diffusion processes generally entail reacting the surface of a component with an aluminum-containing gas composition to form two distinct zones, the outermost of which is an additive layer containing an environmentally-resistant intermetallic represented by MAl, where M is iron, nickel or cobalt, depending on the substrate material. Beneath the additive layer is a diffusion zone that includes various intermetallic and metastable phases that form during the coating reaction as a result of diffusion gradients and changes in elemental solubility in the local region of the substrate. During high temperature exposure in air, the MAl intermetallic forms a protective aluminum oxide (alumina) scale or layer that inhibits oxidation of the diffusion coating and the underlying substrate.

High reliability TBC bond coats consisting of a NiAl overlay coating is highly sensitive to aluminide processing. Aluminide before and/or after the NiAl coating can result in substantial degradation of the TBC cyclic life. However, in order to protect the inside cooling passages from oxidation and hot corrosion, a vapor phase aluminide is required. This cross-functional requirement between external and internal surfaces of a turbine part forces a highly labor intensive and costly process of vapor phase aluminiding (VPA) coating, wax filling of internal passages to protect internals, chemical stripping of aluminide from external surfaces and protecting the internal passages while chemical processing. Additionally, these steps add the risk of chemically attacking the coating deposited on the internal passages.

Known process technology consists of VPA coating, at about 1800° F. to about 2000° F., the entire blade including both internal and external surfaces, filling inside passages with wax to protect from chemical attack, striping Al from the external surfaces by chemical surface treatment, removing the wax, and heat tint to assure that all aluminide is removed. These process steps can add a cost penalty and about 7-10 days of added manufacturing time.

### BRIEF DESCRIPTION OF THE INVENTION

In one aspect, a method of forming a metal coating on surfaces on a turbine part is provided. The method includes positioning the turbine part in a VPA chamber, coupling a gas manifold to at least one internal passage inlet, and coating the internal surface and the external surface of the turbine part by a vapor phase aluminiding (VPA) process using metallic coating gases to form an aluminide coating on the internal surfaces of the turbine part and a coating at least partially over the bond coating.

In another aspect, a method of forming a metal coating on surfaces of internal passages of a turbine part, the turbine part having an outer surface and including at least one internal passage is provided. The method includes applying a highly oxidation resistant nickel aluminide (NiAl) bond coat to the external surfaces of the turbine part, positioning the blade in VPA coating chamber, placing a source of aluminum in the form of small chunks, introducing a halide compound to form gaseous vapor at higher temperatures, and forming an aluminide coating at both internal surfaces and external surfaces.

### BRIEF DESCRIPTION OF THE DRAWINGS

FIG. 1 is schematic illustration of a gas turbine engine.

FIG. 2 is a perspective schematic illustration of an exemplary turbine rotor blade shown in FIG. 1.

FIG. 3 is an internal schematic illustration of the turbine rotor blade shown in FIG. 2.

FIG. 4 is an internal schematic illustration of the turbine rotor blade shown in FIG. 2 coupled to a vapor phase aluminiding manifold.

FIG. 5 is a schematic illustration of a vapor phase aluminiding system.

FIG. 6 is a flow diagram of a method of coating the exemplary turbine rotor blade shown in FIG. 2.

### DETAILED DESCRIPTION OF THE INVENTION

A method of coating the internal and external surfaces of a turbine part, such as a rotor blade for example, with an oxidation resistant coating while maintaining the performance of nickel aluminide coating is described below in detail. The method includes coating the external surfaces of the turbine part with a nickel aluminide coating and utilizing a vapor phase aluminiding process to deposit a protective coating on the internal and external surfaces of the turbine part to protect the turbine part from oxidation and hot corrosion. The uniqueness of the process parameters is designed in such a way so as to provide an equilibrium composition of aluminide vapors with nickel aluminide external surfaces while providing coating to internal surfaces.

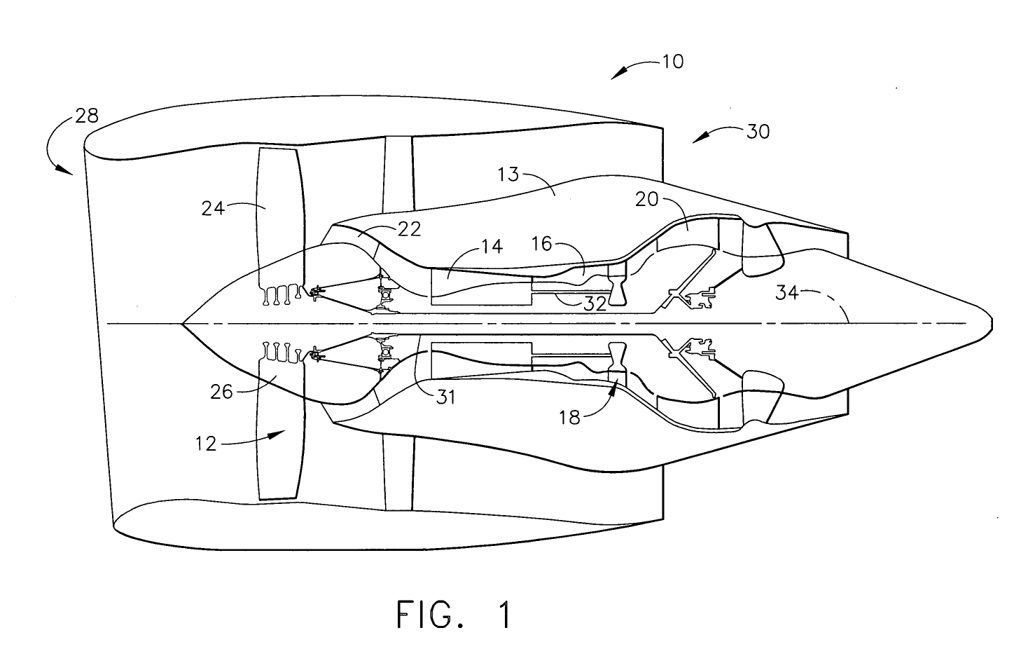

Referring to the drawings, FIG. 1 is a schematic illustration of a gas turbine engine 10 that includes a fan assembly 12 and a core engine 13 including a high pressure compressor 14, a combustor 16, and a high pressure turbine 18. Engine 10 also includes a low pressure turbine 20, and a booster 22. Fan assembly 12 includes an array of fan blades 24 extending radially outward from a rotor disc 26. Engine 10 has an intake side 28 and an exhaust side 30. In one embodiment, the gas turbine engine is a GE90 available from General Electric Company, Cincinnati, Ohio. Fan assembly 12 and turbine 20 are coupled by a first rotor shaft 31, and compressor 14 and turbine 18 are coupled by a second rotor shaft 32.

During operation, air flows through fan assembly 12, along a central axis 34, and compressed air is supplied to high pressure compressor 14. The highly compressed air is delivered to combustor 16. Airflow (not shown in FIG. 1) from combustor 16 drives turbines 18 and 20, and turbine 20 drives fan assembly 12 by way of shaft 31.

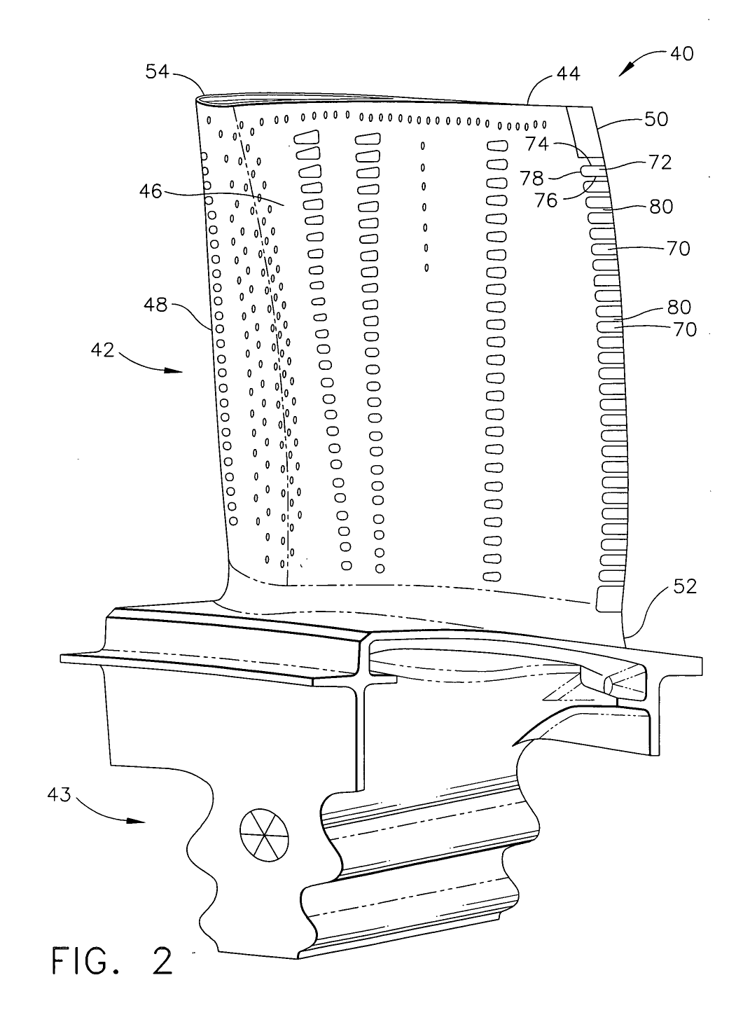

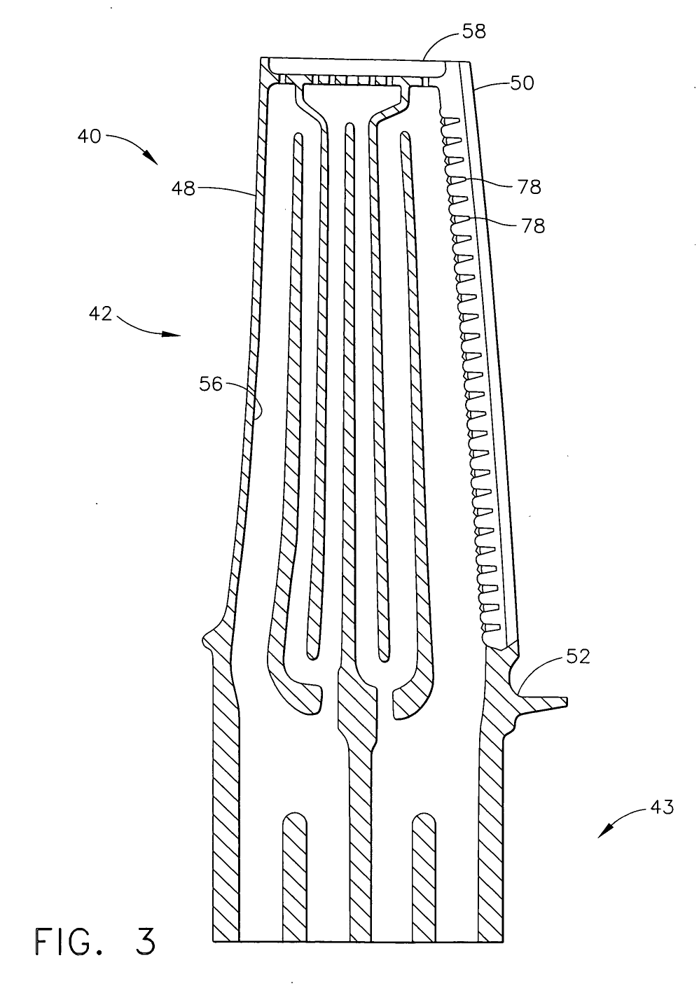

FIG. 2 is a perspective schematic illustration of a turbine part that may be used with gas turbine engine 10 (shown in FIG. 1). FIG. 3 is an internal schematic illustration of the turbine part. In the exemplary embodiment, the method is described herein with respect to a turbine rotor blade 40, however the method is not limited to turbine blade 40 but may be utilized on any turbine part. Referring to FIGS. 2 and 3, in an exemplary embodiment, a plurality of turbine rotor blades 40 form a high pressure turbine rotor blade stage (not shown) of gas turbine engine 10. Each rotor blade 40 includes a hollow airfoil 42 and an integral dovetail 43 used for mounting airfoil 42 to a rotor disk (not shown) in a known manner.

Airfoil 42 includes a first sidewall 44 and a second sidewall 46. First sidewall 44 is convex and defines a suction side of airfoil 42, and second sidewall 46 is concave and defines a pressure side of airfoil 42. Sidewalls 44 and 46 are connected at a leading edge 48 and at an axially-spaced trailing edge 50 of airfoil 42 that is downstream from leading edge 48.

First and second sidewalls 44 and 46, respectively, extend longitudinally or radially outward to span from a blade root 52 positioned adjacent dovetail 43 to a tip plate 54 which defines a radially outer boundary of an internal cooling chamber 56. Cooling chamber 56 is defined within airfoil 42 between sidewalls 44 and 46. Internal cooling of airfoils 42 is known in the art. In the exemplary embodiment, cooling chamber 56 includes a serpentine passage 58 cooled with compressor bleed air.

Cooling cavity 56 is in flow communication with a plurality of trailing edge slots 70 which extend longitudinally (axially) along trailing edge 50. Particularly, trailing edge slots 70 extend along pressure sidewall 46 to trailing edge 50. Each trailing edge slot 70 includes a recessed wall 72 separated from pressure sidewall 46 by a first sidewall 74 and a second sidewall 76. A cooling cavity exit opening 78 extends from cooling cavity 56 to each trailing edge slot 70 adjacent recessed wall 72. Each recessed wall 72 extends from trailing edge 50 to cooling cavity exit opening 78. A plurality of lands 80 separate each trailing edge slot 70 from an adjacent trailing edge slot 70. Sidewalls 74 and 76 extend from lands 80.

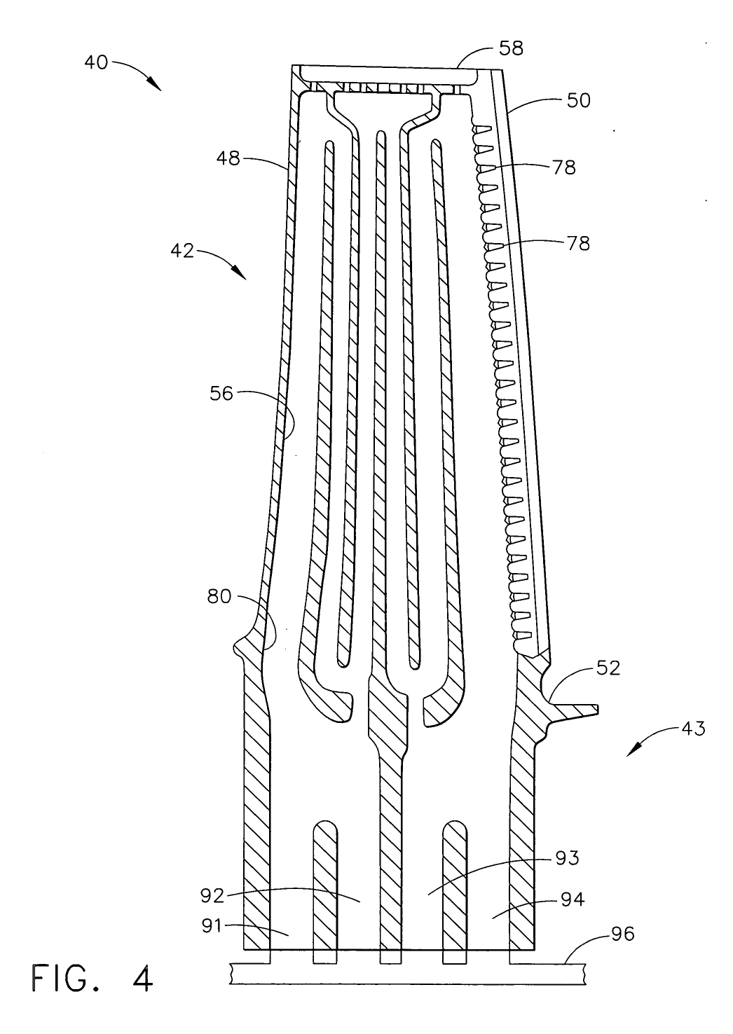

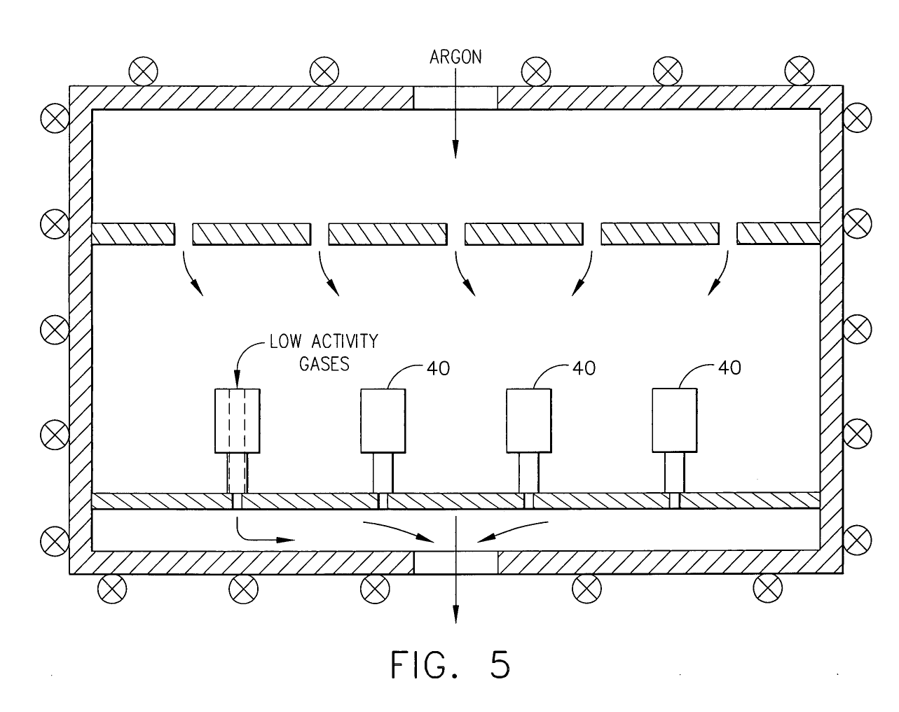

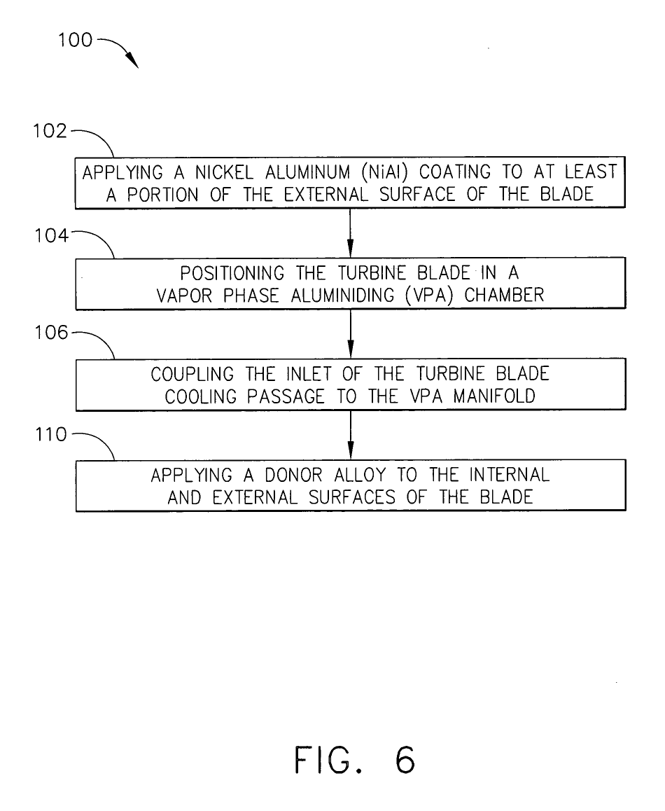

Referring also to FIGS. 4, 5, and 6, in the exemplary embodiment, to protect both the internal and external surfaces of the turbine part, e.g. turbine rotor blade 40, from oxidation and hot corrosion, turbine part 40 is coated by a process 100 to deposit a nickel aluminide (NiAl) coating on the exterior surface of airfoil 42. Specifically, the nickel aluminide coating is applied to at least a portion of first sidewall 44 and second sidewall 46. In the exemplary embodiment, the nickel aluminide coating is applied 102 to substantially the entire external surface of airfoil 42 to a thickness between approximately 0.001 inches (1 mil) and approximately 0.003 inches (3 mils). In the exemplary embodiment, the nickel aluminide coating is a base coat that is applied 102 to substantially the entire external surface of airfoil 42 to a thickness of approximately 0.002 inches (2 mils). The nickel aluminide coating is generally an aluminide bond coat that may include aluminum, nickel, zirconium, and/or chromium.

In the exemplary embodiment, the nickel aluminide bond coating is applied to airfoil 42 using a line-of-sight process such as an ion plasma deposition process, electron beam physical deposition (EB-PVD), or any other high energy deposition processes.

The externally coated turbine part 40 is then positioned 104 within a vapor phase aluminiding (VPA) chamber 88 of a VPA coating system 90. The vapor phase aluminiding system includes the donor alloy pellets of chromium-aluminum, cobalt-aluminum, or nickel-aluminum composition, a halide activator to produce aluminum containing vapors, a source of heat (furnace), and a manifold to flow gases through internal surfaces.

In the exemplary embodiment, the donor alloy is a chromium-aluminum composition. Specifically, a temperature within chamber 88 is set between approximately 1800° Fahrenheit (F) and approximately 2050° F. In the exemplary embodiment, a temperature within chamber 88 is set to approximately 1975° F. and the aluminide gases are then generated from the reaction of the chrome-aluminum donor alloy and the halide gased into chamber 88 such that a portion of the aluminum gases is deposited on the external and internal surface of airfoil 42 over a period of time between approximately thirty minutes and approximately four hours, generally approximately two hours. In the exemplary embodiment, the aluminide coating is deposited to a thickness between approximately 0.0005 inches (½ mil) and approximately 0.0015 inches (1.5 mils) on the internal surfaces of turbine part 40 with negligible or a very small amount of coating being deposited on the external surface of turbine part 40. The chemical composition of the chromium-aluminum donor alloy and the activator are contained in the VPA chamber to produce aluminum halide gases with an activity of aluminum, namely the mole fraction of aluminum in the gases, so that a required aluminum coating is obtained in the internal surfaces while the external nickel aluminide surface remains unchanged in chemical composition, or experiences a minor change in chemical composition. In a more preferred embodiment, the chemical composition of chrome-aluminum donor alloy is about 80 weight percent of chromium and 20 weight percent of aluminum. The donor alloy is preferably lower in aluminum composition compared to present conventional practice of using donor alloy of composition between about 30 weight percent aluminum to 50 weight percent aluminum. The primary theoretical mechanism includes that the amount of aluminum in the low activity aluminum donor alloy is sufficient to give aluminum to nickel-base alloy whereas the aluminum in the donor alloy is not high enough to transfer additional aluminum to the nickel aluminide bond coat. Due to the preferred composition of the low activity of aluminum in the vapor phase in the aluminum halide gases, the external surface of the turbine part containing the nickel aluminide bond coat remains practically the same as before the vapor phase treatment. In the preferred embodiment, the aluminum halide activator (AIF3) is between approximately 0.3 and 0.5 grams of AIF3 for 1 cu.ft/hr of transport gas. In the preferred embodiment, the transport gases may be hydrogen, helium, nitrogen and argon. The most preferred gas is hydrogen. In the most preferred embodiment, the flow of transport gases is designed proportionally to provide aluminiding vapor flow through internal cavities, while simultaneously substantially decreasing the activity of aluminiding gases to obtain equilibrium with the external coating of nickel aluminide. In the preferred embodiment, it is estimated that the flow of transport gases of five equivalent volume of coating chamber 88 per hour reduces activity of aluminum by about 5 percent. The most preferred range of transport gas flow is between approximately 100 and 200 cu.ft/hr.

The aluminizing process is run for a period of time in the range of about 1 hour to about 10 hours depending on the temperature at which the turbine part is aluminided. In the preferred embodiment, the time of aluminiding is kept at the low end of this range to lower aluminum activity. In a most preferred process, the time is approximately 2 hours at a temperature of approximately 1975° Fahrenheit (1070° Celsius).

The above described process 100 provides for coating the external surfaces of turbine part 40 with a protective NiAl coating to protect the external surfaces from corrosion and/or oxidation. Furthermore, the NiAl coating is an oxidation resistant bond coat for the electron beam physical vapor deposition (EB-PVD) thermal barrier coating. The most preferred embodiment of this invention provides the NiAl bond coat under original condition with no degradation in various performance.

Specifically, process 100 includes using a VPA system to provide internal aluminiding with an equilibrium activity aluminum vapors such that the external surface of the blade does not get over-aluminided while the internal surfaces of the blade receive a coating that has a desired thickness

While the invention has been described in terms of various specific embodiments, those skilled in the art will recognize that the invention can be practiced with modification within the spirit and scope of the claims.

What is claimed is:

1. A method of forming a metal coating on surfaces of internal passages of a turbine part, the turbine part having an outer surface and comprising at least one internal passage, said method comprising:
applying a nickel aluminum bond coating to an external surface of the turbine part;
positioning the turbine part in a VPA chamber;
coupling a gas manifold to at least one internal passage inlet;
exposing the turbine part to a low activity chromium and aluminum donor alloy; and
coating at least a portion of the internal surface of the turbine part by a vapor phase aluminiding (VPA) process to form a nickel aluminide coating of on at least a portion of the external surfaces of the turbine component, the nickel aluminide coating having a composition of approximately twenty four weight percent aluminum, approximately six weight percent of chromium, and approximately two weight percent of Zirconium.

2. A method in accordance with claim 1 wherein exposing the turbine part to a low activity chromium and aluminum donor alloy further comprises exposing the turbine part to a donor alloy composition including chromium and aluminum, the composition including between approximately ten weight percent aluminum and approximately twenty four weight percent aluminum.

3. A method in accordance with claim 1 wherein the coating is formed at the internal surface by reaction of aluminum halide gases with the metal surface.

4. A method in accordance with claim 1 further comprising of heat treating the metal coating at about 1900° F. to about 2050° F. for about 30 minutes to about 4 hours.

5. A method in accordance with claim 1 further comprising applying a bond coating between approximately 0.001 inches and approximately 0.003 inches in thickness to the external surface of the turbine part.

6. A method in accordance with claim 1 further comprising applying an aluminum coating between approximately 0.0005 inches and approximately 0.0015 inches in thickness to at least a portion of the internal surface of the turbine parte.

7. A method in accordance with claim 1 further comprising applying a coating approximately between approximately 0.001 inches and approximately 0.003 inches in thickness to at least a portion of the external surface of the turbine part.

8. A turbine part having a coating on the internal and external surfaces of the part wherein the metal coating is formed in accordance with claim 1.

9. A turbine part in accordance with claim 8 wherein the bond coating is between approximately 0.001 inches and approximately 0.003 inches in thickness.

10. A turbine part in accordance with claim 8 wherein the coating is between approximately 0.0005 inches and approximately 0.0015 inches in thickness on at least a portion of the internal surface of the turbine part.

11. A turbine part in accordance with claim 8 wherein the coating is between approximately 0.001 inches and approximately 0.003 inches in thickness on at least a portion of the external surface of the turbine part.

12. A method of forming a metal coating on surfaces of internal passages of a turbine part, the turbine part having an outer surface and comprising at least one internal passage, said method comprising:
applying a nickel aluminum bond coating to an external surface of the turbine part;
positioning the turbine part in a VPA chamber;
coupling a gas manifold to at least one internal passage inlet;
flowing gases through the manifold and into the at least one internal passage to form a coating on the surfaces of the at least one internal passage; and
pumping metal reagent gases into the VPA chamber to form a coating on the external surface of the turbine part.

13. A method in accordance with claim 12 wherein the coating gases comprise at least one of an aluminum halide gas.

14. A method in accordance with claim 13 further comprising heat treating the coating at about 1900° F. to about 2050° F. for about 30 minutes to about 4 hours.

15. A method in accordance with claim 13 further comprising applying a bond coating between approximately 0.001 inches and approximately 0.003 inches in thickness to the external surface of the turbine part.

16. A method in accordance with claim 12 further comprising applying an aluminum coating between approximately 0.0005 inches and approximately 0.0015 inches in thickness to at least a portion of the internal surface of the turbine part.

17. A method in accordance with claim 12 further comprising applying an aluminum coating between approximately 0.001 inches and approximately 0.003 inches in thickness to at least a portion of the external surface of the turbine part.

18. A method in accordance with claim 12 wherein the turbine part comprises an airfoil and a plurality of passages defined within the airfoil, said method further comprising applying a coating between approximately 0.0005 inches and approximately 0.0015 inches in thickness to the passages defined within the airfoil.
